(19) United States
(12) Patent Application Publication
(10) Pub. No.: US 2002/0152383 A1
(43) Pub. Date: Oct. 17, 2002

(54) Method for measuring the latency of certificate providing computer systems

(76) Inventors: Robert E. Walsh, Foster City, CA (US); Gerald Beuchelt, Burlington, MA (US)

Correspondence Address: HOYT A. FLEMING III, P.O. BOX 140678, BOISE, ID, 83714, US

(21) Appl. No.: 09/836,715

(22) Filed: Apr. 16, 2001

(51) Int. Cl. H04L 9/00

(52) U.S. Cl. 713/176

(57) ABSTRACT

A method of measuring the latency of a computer system comprising: generating a request for certificate certification that includes a distinguished name, a public key and data that indicates a usage of the public key; sending the request for certificate certification to the computer system; determining the time that the request for certificate certification was sent; receiving a certificate from the computer system; determining the time that the certificate was received; determining whether the certificate contains information that indicates whether the public key may be utilized for the usage indicated in the data; and determining the difference between the time that the request for certificate certification was sent and the time that the certificate was received.

### 1. FIELD OF THE INVENTION

The present invention generally relates to methods of measuring the latency of servers. More specifically, the present invention relates to methods of measuring the latency of servers that provide certificates with public key-usage information.

### 2. BACKGROUND

Cryptography is the science of protecting data. Cryptographic algorithms mathematically combine data and an encryption key to generate encrypted data. With a good cryptographic algorithm, it is computationally not feasible to reverse the encryption process and to derive the input data.

One cryptographic system that is in widespread use today is known as public key cryptography. In public key cryptography, a first party utilizes a private key to encrypt data. The encrypted data is then sent to a second party via an insecure means, such as the Internet. After receiving the encrypted data, the second party utilizes a second key, known as a public key, to decrypt the input data. The public key is related to but is not identical to the private key. Thus, in public key cryptography, every user has a pair of keys: a public key and a private key. By making the public key available to others, it is possible to enable others to send the user encrypted data that can only be decrypted using the user's private key. Similarly, the user can encrypt data using the user's private key in such a way that others can verify that it originated with the user.

One aspect of public key cryptography is creating and validating digital signatures. A digital signature is a digital code that can be attached to an electronically transmitted message that uniquely identifies the sender. Like a written signature, the purpose of a digital signature is to guarantee that the individual sending the message really is who he or she claims to be. Validation of digital signatures is based upon the mathematical transform that combines a private key with the data to be signed in such a way that only someone possessing the private key could have created the digital signature. Thus, anyone with access to the corresponding public key can verify the digital signature and can verify that the data has not been modified. Therefore digital signatures can be utilized to provide a very secure data-integrity mechanism.

As discussed above, a user may desire to allow others to have access to the user's public key. If the user transfers the user's public key, via a secure means, to another party, then the other party will trust the authenticity of the user's public key. However, if the user transfers the user's public key via an insecure method to another party, the other party does not know if the user's public key is authentic. One method of verifying public key authenticity is based upon receiving a certificate issued by a certificate authority.

Certificates provide a mechanism for gaining confidence in the relationship between a public key and the entity that “owns” the corresponding private key. A certificate is a digitally signed statement that contains a particular public key and the (distinguished) name of the owner of the private key that corresponds to the public key. The issuer of the certificate signs the certificate with its own private key. A certificate, may also include the serial number of the certificate, the signature algorithm identifier, the issuer of the digital certificate, which often includes the issuing certificate authority's Uniform Resource Locator (URL), and the version number of the certificate format. The most common format of certificates in use today is based upon the International Telecommunication Union T-X.509 standard (the X.509 standard). However, other formats of certificates are also in use.

One form of certificate is defined by version 3 of the X.509 specification. This certificate optionally includes a sub-structure that includes one or more extensions. Thus, a version 3 X.509 certificate can have none, one, or more extension fields. Each extension is defined by an Object Identifier (OID), which is discussed in the following paragraph. A number of standard extensions are defined by industry standard organizations. However, various industry groups may also define other extensions. Extensions may take many forms. One use of extensions is to enforce a particular security policy. For example, one extension is called key-usage. This extension contains key-usage data that is used to indicate the intended use of the public key. For example, the public key may be intended for key encipherment, data encipherment, key agreement, digital signature, non-repudiation, or certificate signing. Alternatively, the public key may be used to allow access to certain computer resources such as files, portions of files, databases, database records, servers, routers, clients, and/or networks. Further, the public key may be used to allow access to certain physical locations such as secure buildings or secure rooms.

An OID is a string of numbers, such as “1.2.3.4.5,” that forms a globally unique address for an X.400 object, such as an entry in a directory service. X.400 is an international message-handling standard for connecting e-mail networks to each other and to messaging users. The International Telecommunications Union (ITU) publishes the X.400 specification. A directory service addressed with a particular OID may provide information relating to specific uses of public keys. For example, a directory service addressed by a particular OID may provide a certificate to be used with a smart card to access a particular secure building.

A certificate authority is an entity that issues certificates. The certificate authority guarantees that the distinguished name identified in the certificate actually “owns” the public key included in a certificate. One obtains a certificate by providing the certificate authority with a distinguished name and the distinguished name's alleged public key and then requesting certificate certification from the certificate authority.

When a user obtains a certificate from a certificate authority, the user can use the public key of the certificate authority to decrypt the information contained in the certificate. However the user may not know that the certificate authority's public key actually belongs to the issuing certificate authority.

One method of verifying that the issuing certificate authority owns the certificate authority's public key is to construct a chain of certificates. This chain traverses from the issuing certificate authority through a series of other certificate authorities and terminates in a certificate from an entity that the user implicitly trusts. Such a certificate is known as a trusted root certificate because it forms the root of a hierarchy of public keys/identity bindings that the user accepts as authentic.

When a certificate authority receives a request for a certificate, the certificate authority accesses information contained in its databases and/or directories to process the certificate request. In order to access such information, specialized protocols have been developed. One such protocol is known as X.500. Another such protocol is known as the lightweight directory access protocol (LDAP). The LDAP protocol is based upon the X.500 protocol but is less complex. As a result, the LDAP protocol is sometimes referred to as X.500-lite.

Currently, there are numerous certificate authorities that issue certificates. These certificate authorities strive to provide higher quality authentication services than their competitors provide. For example, a certificate authority may strive to issue certificates for a larger number of public key owners than its competitors. In addition, the certificate authority may strive to issue such certificates more rapidly than its competitors. By promptly providing such certificates, the certificate authority may increase its business and, hence, its profits.

### 3. SUMMARY OF THE INVENTION

One embodiment of the invention is a method of measuring the latency of a computer system. The method includes: generating a request for certificate certification that includes a distinguished name, a public key and data that indicates a usage of the public key; sending the request for certificate certification to the computer system; determining the time that the request for certificate certification was sent; receiving a certificate from the computer system; determining the time that the certificate was received; determining whether the certificate contains information that indicates whether the public key may be utilized for the usage indicated in the data; and determining the difference between the time that the request for certificate certification was sent and the time that the certificate was received. In some embodiments, the certificate is received with a chain of other certificates using public standards such as Public Key Cryptographic Standards. In other embodiments, the certificate is received without any other certificates.

Another embodiment of the invention is a method of measuring the latency of a computer system. The method includes: generating a plurality of requests for certificate certification, each of the requests in the plurality of requests including a distinguished name, a public key and data that indicates a usage of the public key; sending the plurality of requests for certificate certification to the computer system; determining the time that each of the plurality of requests for certificate certification was sent; receiving a plurality of certificates from the computer system, each of the plurality of certificates corresponding to one of the plurality of requests for certificate certification; determining the time that each of the plurality of the certificates was received; determining whether each of the plurality of the certificates contains information that indicates whether the public key included in the corresponding request for certificate certification may be utilized for the usage indicated in the data included in the corresponding request for certificate certification; and for each of the plurality of requests for certificate certification, determining the difference between the time that the request for certificate certification was sent and the time that the corresponding certificate was received.

### 4. BRIEF DESCRIPTION OF THE FIGURES

FIG. 1 presents a block diagram of two computer systems.

FIG. 2 presents a flow chart of a method of measuring the latency of a computer system.

FIG. 3 presents a flow chart of another embodiment of the invention.

FIG. 4 presents another flow chart of a method of measuring the latency of a computer system.

### 5. DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

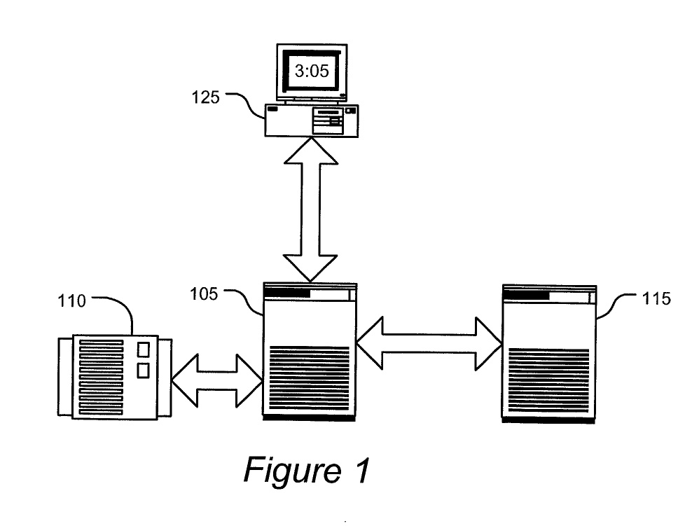

FIG. 1 presents a first computer system 105. The first computer system 105 is coupled to a first disk array 110, which may contain a plurality of distinguished names and alleged public keys for the distinguished names. The public keys and the distinguished names may be stored in a variety of formats on the first disk array 110. In some embodiments, such information may be stored in a relational database, a hierarchical database or in a directory services, such as a X.500 directory service.

The first computer 105 is also coupled to a second computer 115. The first computer 105 may be coupled to the second computer 115 via a variety of means. In one embodiment, the coupling would be via the Internet. In other embodiments, the coupling may be via a virtual private network, an intranet, or any other network or combination of secure or insecure networks. The second computer 115 may also be coupled to a number of other computers (not shown).

The first computer system 105 is also coupled to a third computer system 125. The first computer system 105 may be coupled to the third computer system 125 by any of the means discussed above. In some embodiments of the invention, the third computer system 125 contains a trusted time reference.

5.1 Generating a Request for Certificate Certification

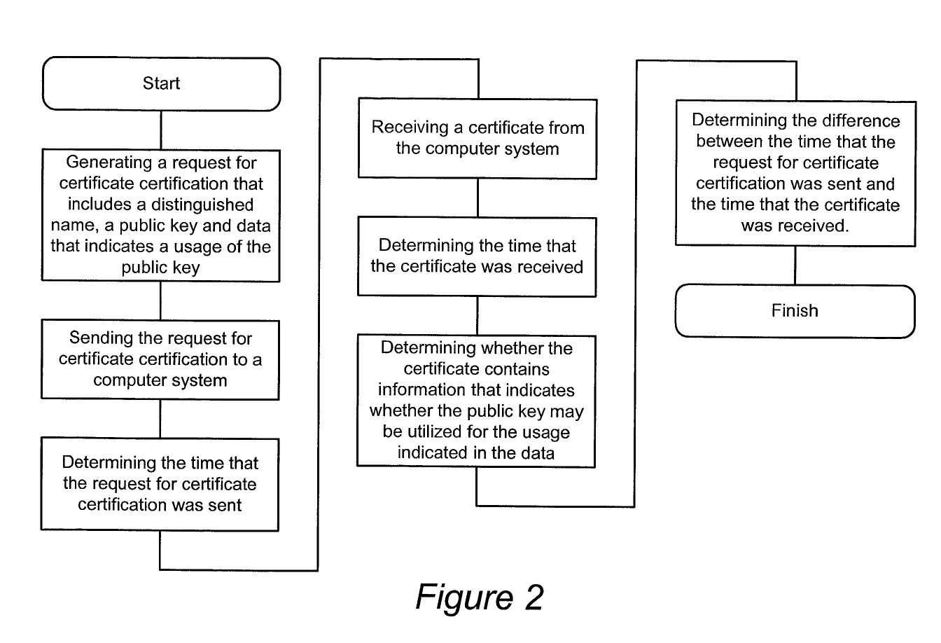

One embodiment of the invention, which may be performed by the computer systems 105 and 115, shown in FIG. 1, is a method of measuring the latency of computer system 115. A flow chart of this method is presented in FIG. 2. In this embodiment, the first computer system 105 obtains a distinguished name and a public key that may or may not be “owned” by the distinguished name. In some embodiments; of the invention, such information is obtained from one or more databases or directories that are accessible to the computer system 115. For example, the first computer system 105 may obtain such information from the first disk array 110. Alternatively, the information may be obtained from another computer system (not shown).

Next, the computer system 105 generates key-usage data that indicates the purpose for which the public key is to be used. In some embodiments of the invention, the key-usage data contains an object identifier (OID).

The first computer system 105 then digitally signs the distinguished name, the public key, and the key-usage data with a private key, such as the private key of the “owner” of the first computer system 105 to form a request for certificate certification. In one embodiment of the invention, the request for certificate certification may be in a format that complies with Public Key Cryptography Standard No. 10 (PKCS No. 10). In other embodiments of the invention, the request for certificate certification may be in other formats such as Public Key Cryptography Standard No. 7 (PKCS No. 7) or Netscape's KeyGen format.

5.2 Sending the Request for Certificate Certification Referring again to FIG. 2, after the request for certificate certification has been generated, the request can be sent to the second computer system 115, which may be operated by a certificate authority. In one embodiment, the request for certificate certification may be sent to the second computer system 115 via a secure network. In other embodiments of the invention, the request for certificate certification may be sent to the second computer 115 via one or more insecure networks such as the Internet.

5.3 Determining the Time that the Request for Certificate Certification was Sent

Referring again to FIG. 2, the time that the request for certificate certification was sent by the first computer system 105 may be determined. One method for determining when the request was sent is by accessing the first computer system's real-time clock. Alternatively, the first computer system 105 may access a third computer system 125, which contains a trusted time reference.

5.4 Generating a Certificate

When the second computer 115 receives the request for certificate certification, the second computer 115 processes the request. Using methods that are known in the art, which may include accessing one or more directory services in a certificate hierarchy and/or the X.400 object identified by the supplied OID, the second computer system 115 determines if the public key included in the request for certificate certification is actually “owned” by the distinguished name and whether the public key may be used for the intended purpose specified in the key-usage data. After such verification, the second computer system 115 generates a certificate that indicates whether the public key may be used for the purpose indicated in provided key-usage data.

In one embodiment, the format of the certificate may be compliant with version 3 of the X.509 standard. Certificates that comply with version 3 of the X.509 standard contain the distinguished name of the certificate issuer, i.e., the owner/operator of the second computer system 115, an issuer-specific serial number, the issuer's signature algorithm identifier, and a validity period for the certificate. In addition, the certificate would include one or more X.509 extensions that indicate the purpose that the public key may be used for. After the certificate has been generated, the certificate is sent to the first computer system 105 via an insecure or secure network.

5.5 Receiving a Certificate from the Computer System

Referring again to FIG. 2, the first computer system 105 then receives the certificate. In some embodiments of the invention the certificate is stored in Random Access Memory (RAM). In other embodiments, the certificate is stored in a file, in a directory, or even in a smart card.

5.6 Determining the Time that the Certificate was Received

Next, the time that the certificate was received is determined as shown in FIG. 2. In some embodiments of the invention, the time to receive the first data packet of the certificate is determined. In other embodiments of the invention, the time to receive the last data packet of the certificate is determined. In still other embodiments, the average of the time to receive the first and the last data packets is determined. In still other embodiments, the time for both the first and the last data packet of the certificate is determined. In other embodiments, the time that the last data packet of the complete chain of certificates was received is determined. The above receipt times may be determined by the same methods discussed in Section 5.3.

5.7 Determining the Difference between the Time that the Request for Certificate

Certification was Issued and the Time that the Certificate was Received By comparing the time difference between requesting certificate certification and receiving the certificate, the latency of the second computer 115 may be determined.

5.8 Verifying the Received Certificate

Unfortunately, the mere receipt of a certificate from an entity, such as a certificate authority, does not insure that the requested data can be derived from the certificate. One reason for this difficulty is that the specifications that define the requirements of certificates are very complex. It is common for implementers to either incorrectly implement or misinterpret one or more of the standards. As discussed in the Background Section, the introduction of version 3 X.509 certificates added a new sub-structure—that of extensions. Unfortunately, the implementation of extensions varies among implementers and many of the implementations are incompatible.

A second reason for the above difficulty is that the certificate may have been signed using an algorithm that is not supported by the software running on the first computer 105.

Because the mere receipt of a certificate does not insure that the requested data can be derived from the certificate, after receipt of the certificate, the first computer system 115 verifies that the received certificate actually contains the requested data. For example, the request for certificate certification may have requested verification that a public key could be used by a distinguished name for accessing a particular computer system. However, the received certificate may indicate that the public key may be used for secure email and does not provide any information relating to whether the public key may be used for accessing the computer system. Thus, when the first computer 115 verifies the certificate, the certificate would be found to be deficient. In another embodiment of the invention, the first computer 115 would verify that the complete chain of certificates was received.

In one embodiment of the invention, the deficiencies of the certificate may be stored by the first computer system 105. These deficiencies may be utilized to determine whether the first computer system 105 is interoperable with the second computer system 115 as discussed in Section 5.8.

5.9 Other Embodiments of the Invention

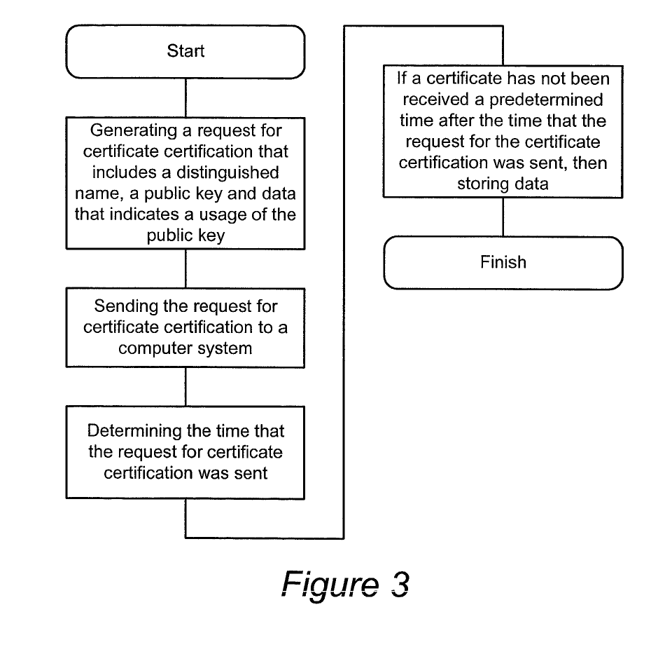

In some embodiments of the invention, if a certificate is not received within a predetermined time after the request for certificate certification was sent, then an error message is generated and data is stored by the first computer system 105 that indicates the request for certificate certification for which no certificate was received. A flow chart of one such embodiment is presented in FIG. 3.

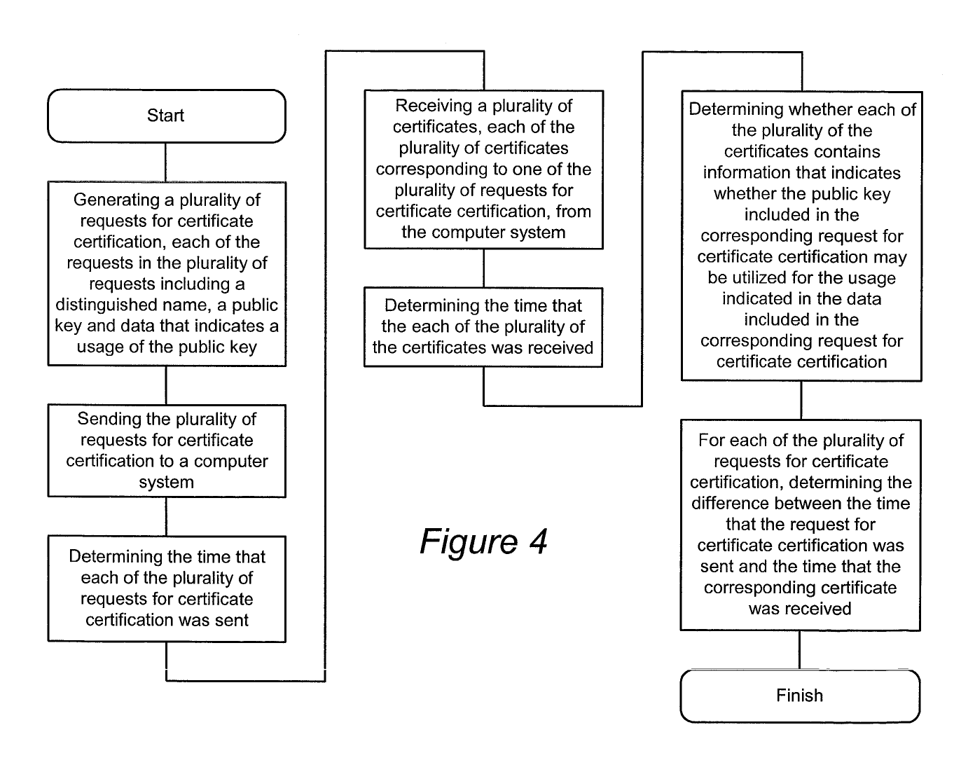

Another embodiment of the invention generates a number of requests for certification and then sends the requests to the second computer 115 in a short period of time. A flow chart of one such embodiment is presented in FIG. 4. For example, the first computer 105 may generate 200,000 requests for certification and then send them to the second computer 115 in a ten second period of time. The time that each such request was sent would be determined as would the time that each requested certificate was received. After the above times were determined, the difference in time between requesting certification and receiving a corresponding certificate would be determined.

In another embodiment of the invention, key-usage data, distinguished names, and/or request formats, would be randomized. Thus, a number of requests for certification could be generated and sent that place different loads on the second computer system 115.

In still another embodiment, the first computer 105 would send a number of requests for certificates to any computer designated by the operator of the first computer. For example, the first computer could request the operator to identify the name and/or address of the second computer 115. After providing the name and/or address of the second computer 115, then a number of requests for certification would be sent to the second computer 115.

5.10 Conclusion

Some of the above embodiments of the invention may be utilized to determine whether a computer system, such as the second computer system 115, can promptly provide a large number of certificates to users. For example, by sending a computer system a large number of requests for certificate certification with predefined key-usage data, the time period required by the computer system to provide the requested certificates can be determined.

In addition, some of the above embodiments of the invention can be used to determine if the first computer system 105 is partially or fully interoperable with the second computer system 115. For example, if the second computer 115 always provides receipts that provide data requested by the first computer 105, then the computers are fully interoperable. On the other hand, if the second computer 115 provides some data requested by the first computer 105 but not all the requested data, then the computers are partially interoperable. Such information can be utilized to increase the interoperability of the two computers.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

It is claimed:

1. A method of measuring the latency of a computer system comprising:
a) generating a request for certificate certification that includes a distinguished name, a public key and data that indicates a usage of the public key;
b) sending the request for certificate certification to the computer system;
c) determining the time that the request for certificate certification was sent;
d) receiving a certificate from the computer system;
e) determining the time that the certificate was received;
f) determining whether the certificate contains information that indicates whether the public key may be utilized for the usage indicated in the data; and
g) determining the difference between the time that the request for certificate certification was sent and the time that the certificate was received.

2. The method of claim 1, wherein the act of generating the request for certificate certification includes generating a request that includes an object identifier.

3. The method of claim 1, wherein the act of generating the request for certificate certification includes generating a request that includes a distinguished name and a public key that is owned by the entity that owns the distinguished name.

4. The method of claim 1, wherein the act of generating the request for certificate certification includes generating a request that includes a distinguished name and a public key that is not owned by the entity that owns the distinguished name.

5. The method of claim 1, wherein the act of generating the request for a certificate certification includes digitally signing the distinguished name and the public key.

6. The method of claim 1, wherein the act of generating the request for a certificate certification includes sending a request that complies with the Public Key Cryptography Standard number 10.

7. The method of claim 1, wherein the act of generating the request for a certificate certification includes sending a request that complies with the Public Key Cryptography Standard number 7.

8. The method of claim 1, wherein the act of sending the request for certificate certification to the computer system includes sending a request for certificate certification to a certificate authority.

9. The method of claim 1, wherein the act of sending a request for a certificate includes sending a request that complies with the Public Key Cryptography Standard number 7.

10. The method of claim 1, wherein the act of determining the time that the request for certificate certification was sent includes accessing a third computer system that contains a time reference.

11. The method of claim 1, wherein the act of determining the time that the request for certificate certification was sent includes determining the time that the last data packet of the complete certificate chain was received.

12. The method of claim 1, wherein the act of receiving the certificate includes receiving a certificate that is compliant with a version of the X.509 standard.

13. The method of claim 1, wherein the act of receiving the certificate includes receiving a certificate that is compliant with version 3 of the X.509 standard.

14. The method of claim 1, wherein the act of determining whether the certificate contains information includes determining whether an X.509 extension may be utilized for the usage indicated in the data.

15. The method of claim 1, wherein the act of determining whether the certificate contains information that indicates whether the public key may be utilized for the usage includes receiving a key-usage extension.

16. A method of measuring the latency of a computer system comprising:
a) generating a plurality of requests for certificate certification, each of the requests in the plurality of requests including a distinguished name, a public key and data that indicates a usage of the public key;
b) sending the plurality of requests for certificate certification to the computer system;
c) determining the time that each of the plurality of requests for certificate certification was sent;
d) receiving a plurality of certificates from the computer system, each of the plurality of certificates corresponding to one of the plurality of requests for certificate certification;
e) determining the time that each of the plurality of the certificates was received;
f) determining whether each of the plurality of the certificates contains information that indicates whether the public key included in the corresponding request for certificate certification may be utilized for the usage indicated in the data included in the corresponding request for certificate certification; and
g) for each of the plurality of requests for certificate certification, determining the difference between the time that the request for certificate certification was sent and the time that the corresponding certificate was received.

17. The method of claim 16, wherein the act of generating the plurality of requests for certificate certification includes generating a request that includes an object identifier.

18. The method of claim 16, wherein the act of generating the plurality of requests for certificate certification includes generating a request that includes a distinguished name and a public key that is owned by the entity that owns the distinguished name.

19. The method of claim 16, wherein the act of generating the plurality of requests for certificate certification includes generating a request that includes a distinguished name and a public key that is not owned by the entity that owns the distinguished name.

20. The method of claim 16, wherein the act of generating the plurality of requests for a certificate certification includes digitally signing the distinguished name and the public key for one of the plurality of requests.
